(19) United States
(12) Patent Application Publication
(10) Pub. No.: US 2005/0210691 A1
(43) Pub. Date: Sep. 29, 2005

(54) Angle deciphering device with multiple interface

(76) Inventor: David M. Solak, Seven Hills, OH (US)

Correspondence Address: DAVID M. SOLAK, 4805 MAPLE HILL DRIVE, SEVEN HILLS, OH, 44131-5916, US

(21) Appl. No.: 10/667,715

(22) Filed: Sep. 22, 2003

(51) Int. Cl. G01C 9/06

(52) U.S. Cl. 33/366.24

(57) ABSTRACT

An improved angle deciphering and leveling device that transmits a radio frequency to a receiver located on or near the person using the level and also to a second receiver on or near a person who can double-check the level-user's work. The level works with a tilt switch that rotates about a shaft. The shaft is connected to a knob and spool. The spool is attached to the shaft. The tilt switch is attached to the spool. The tilt switch corresponds to a dial face that reads in angular degrees. When the tradesman sets the knob to the desired angle, the tilt switch corresponds to that angle and when the level is tilted to the preset angle a radio-frequency transmitter is triggered. When the transmission signal is received by the proper same frequency receiver, a alarm will sound verifying the angle has been reached. An on/off power switch will shut off the level when not in use.

### BACKGROUND OF INVENTION

1. Field of Invention

This invention relates to levels, specifically to improve the level by allowing the measure of angular degrees and then transmitting a radio frequency to a another tradesman's receiver packet and triggering an audible alarm for multiple-checking of the tradesman who is using the level work.

2. Description of Prior Art

An audible level known in prior art U.S. Pat. No. 5,313,713 issued May 24, 1994 to Heger et. al. assigned to Zircon Corporation. This level's method of signaling audibly is restricted in it's range by the loudness or decibel of it's electronic alarm. The display of this level is in null form. This device does not give a numerical reading of angular degree. Furthermore, it does not transmit to another tradesman's ear if he/she is out of earshot of the level. So another person may not hear the tone in noiseless, or especially noisy environments. Hearing the tone by a second tradesman would enable a double check of work that may require strict tolerance of a specific angle.

### SUMMARY OF INVENTION

This modification to the level will sound an alarm, when a preset angle is reached, in the ear of the holder and in the ear of another tradesman so that at least two people can check the angular position when one person is at a far distance. This modification is important when quality control is imperative and the environment may not allow mutiple people to check an angle.

### BRIEF DESCRIPTION OF DRAWINGS

FIG. 1. Shows the level with attached transmitter box, antenna, and rotary angle dial-knob.

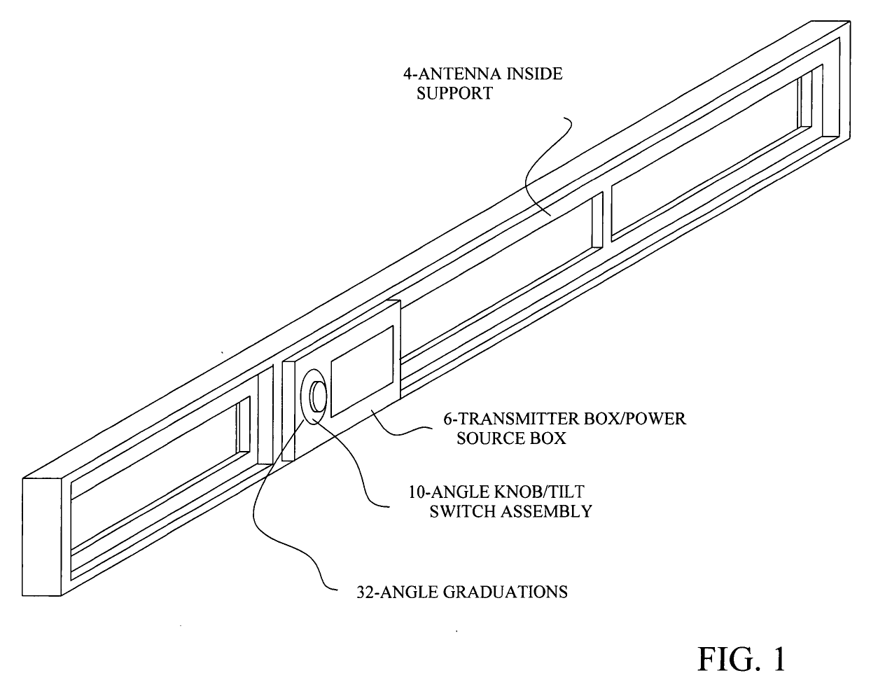

FIG. 2. Shows the rotary-knob with tilt switch and wiper contacts, knob assembly and knob window.

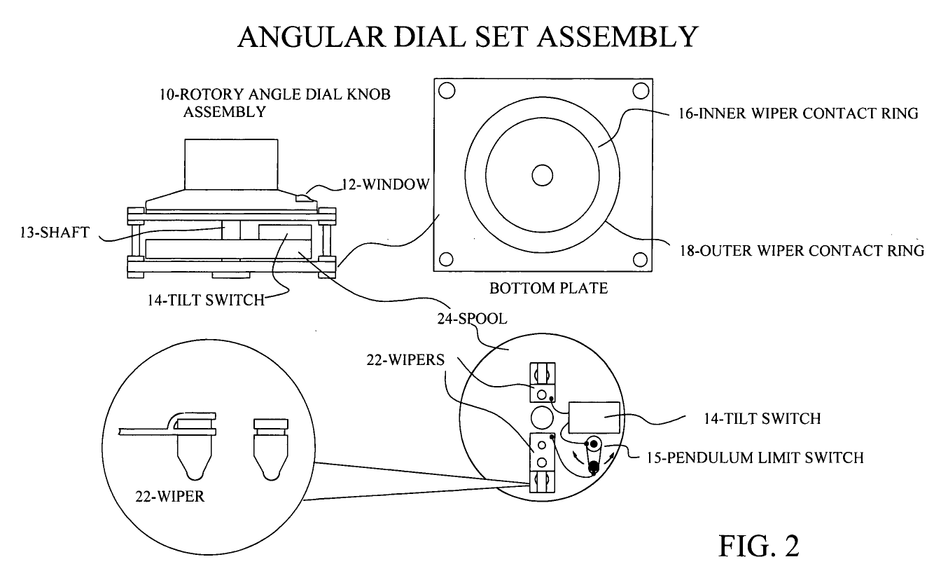

FIG. 3. Shows another view of the knob and how the angular graduations may look.

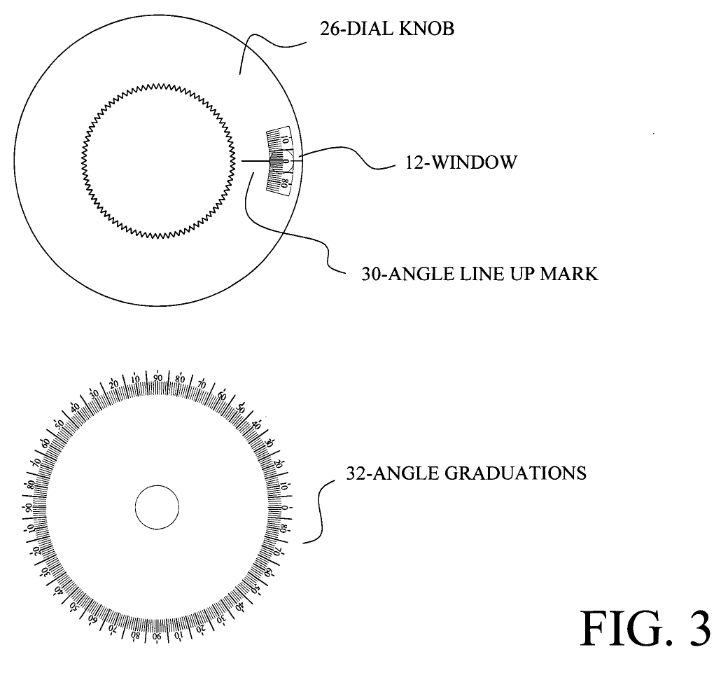

FIG. 4. A hypothetical look at the level transmitting to the receiver.

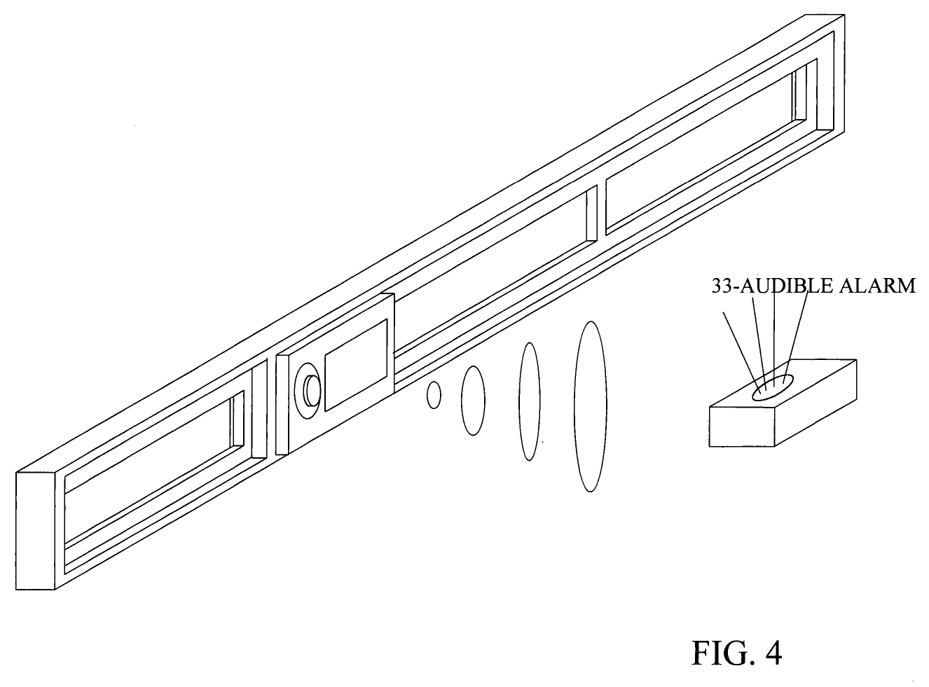

FIG. 5. Shows the transmitter circuit.

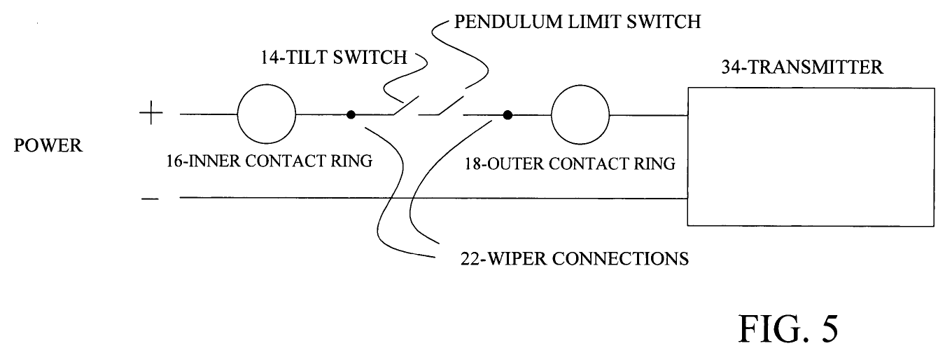

### DETAILED DESCRIPTION OF INVENTION

This level will turn on an audible alarm 33 by remote control through radio frequency transmission technology. The level has the characteristics of a typical level except it has a angle presetting knob 26 that when set, will position a tilt switch 14 to a corresponding angle. By viewing graduations 32 through a window 12 in the knob 26, the desired angle may be set by lining up a line mark 30. A shaft 11 connects the knob 26 to a spool. The tilt switch 14 is fastened to the spool 24. When the knob 26 is rotated the tilt switch 14 rotates correspondingly. Two wipers 22 contact two rings 16, 18 in the knob assembly 10. The rings 16, 18 and wipers 22 are made of an electrical conducting material so that when a circuit is completed through the tilt switch 14 a transmitter 34, located in the level, turns on. The transmission signal reaches a receiver 35 and turns on an audible alarm 33 verifying the angle has been reached. Two or more people can verify the angle has been reached if they carry the properly corresponding receivers 35. If the receivers 35 are of a same frequency and are a part of the system they will correspond to the transmitting level. An antenna 4 will increase range of the transmitter 34 and receiver 35. The transmitter 34 housed in a box 6 on the level. An on off switch will turn off the system when not in use.

1. A hand-held angle deciphering device comprising:
a. a tilt switch for determining the degree of angle of said device; and
b. a wiper contact assembly to complete a circuit between said tilt switch and a radio frequency transmitter; and
c. a means to electrically power the said transmitter and tilt switch; and
d. an antenna to increase the range of said transmitter

2. A rotating Knob comprising:
a. a window; and
b. connected to said tilt switch, in claim 1, so that tilt switch rotates 360 degrees; and
c. degree graduations located so they can be viewed relative to said knob; and
d. a mark on said knob to line up desired angle

3. A radio frequency receiver to receive radio signals from said transmitter in claim 1; comprising:
a. an enclosure housing the receiver; and
b. a means to power the receiver
c. an audible signaling device; and
d. means to hear said audible signal in any enviroment within range of the transmitter; and
e. an antenna to increase the range of said receiver and hand-held deciphering device as described in claim 1
